(19) United States
(12) Patent Application Publication
(10) Pub. No.: US 2003/0198174 A1
(43) Pub. Date: Oct. 23, 2003

(54) Optical pickup apparatus and optical disk apparatus

(76) Inventor: Satoru Kondo, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/339,415

(22) Filed: Jan. 10, 2003

(30) Foreign Application Priority Data
Jan. 16, 2002 (JP) P2002-007945

(51) Int. Cl. G11B 7/00

(52) U.S. Cl. 369/125

(57) ABSTRACT

An optical pickup apparatus and an optical disk apparatus are disclosed by which a land prepit signal is produced appropriately. Outputs of first and fourth light reception regions and outputs of second and third light reception regions of a light reception section are added by first and second adders, respectively. The gains of outputs of the adders are controlled with a predetermined output ratio by respective AGCs, and resulting signals are outputted to respective variable gain amplifiers. Meanwhile, the outputs of the adders are added by a further adder to produce a RF signal, and a gain control signal production section detects presence or absence of a record mark from the RF signal and varies the amplification factors of the variable gain amplifiers based on a result of the detection. A subtractor produces a difference signal from the outputs of the variable gain amplifiers, and a binarization circuit binarizes the difference signal within a predetermined level range to produce a land prepit signal.

### BACKGROUND OF THE INVENTION

This invention relates to an optical pickup apparatus for detecting a prepit signal from a disk wherein prepits are provided on lands such as, for example, an optical disk or a magneto-optical disk and an optical disk apparatus which includes an optical pickup apparatus of the type mentioned.

Conventionally, an optical disk apparatus is available which includes an optical pickup for recording and/or reproducing information onto and/or from an optical disk such as, for example, a DVD-R/-RW (Digital Versatile Disk-Recordable/-Rewritable).

On a recording face of an optical disk of the type described which is recorded and/or reproduced by the optical disk apparatus described above, groove tracks and land tracks on which land prepits representative of position information on the optical disk are provided are formed spirally. The optical disk apparatus uses the optical pickup to detect the land prepits to perform recording and/or reproduction of information while confirming the position on the groove track.

The optical pickup included in such an optical disk apparatus as just described includes a light source for emitting a beam of light, an objective lens for condensing the beam of light emitted from the light source on the recording face of the optical disk, and a light reception section for receiving reflected light from the optical disk.

The optical pickup condenses the beam of light emitted from the light source at a desired position on the optical disk by means of the objective lens, receives returning light reflected from the optical disk by means of the light reception section which has a plurality of light reception regions, and produces various signals such as, for example, a radio frequency (RF) signal, a focusing error signal, a tracking error signal, and a land prepit signal in response to the amount of the received returning light.

In the following, operation of the components of the optical pickup when it detects a land prepit to produce a land prepit signal is described.

The light reception section has, for example, as shown in FIG. 10, four light reception regions 10a, 10b, 101c and 101d divided by divisional lines extending in a direction of a track and another direction perpendicular to the direction of a track and outputs signals corresponding to the amounts of returning light received by the light reception regions 101a, 101b, 101c and 101d to corresponding I-V amplifiers 102a, 102b, 102c and 102d, respectively.

The I-V amplifiers 102a, 102b, 102c and 102d convert the respectively received signals into voltages, and the voltage signals of the I-V amplifiers 102a and 102d are outputted to an adder 103a while the voltage signals of the I-V amplifiers 102b and 102c are outputted to another adder 103b.

The adder 103a adds the signals inputted thereto and outputs a resulting signal to a subtractor 104 while the adder 103b adds the signals inputted thereto and outputs a resulting signal to the subtractor 104. The subtractor 104 subtracts the output signal from the adder 103b from the output signal of the adder 103a and outputs a resulting signal as a difference signal to a binarization circuit 105.

The binarization circuit 105 binarizes the level of the difference signal outputted from the subtractor 104 within an effective range between a predetermined upper limit value and a predetermined lower limit value to produce a land prepit (LPP) signal.

In an optical disk apparatus which includes such an optical pickup as described above, since the difference signal from the subtractor 104 is a radial push-pull signal including a wobble signal and a land prepit does not exist simultaneously on adjacent land tracks which are adjacent to a predetermined place of a groove track, a land prepit component appears on the wobble signal as seen in FIG. 11.

The optical disk apparatus binarizes the land prepit component of the wobble signal within the effective range by means of the binarization circuit 105 to produce a land prepit signal, and detects the position on the optical disk upon which the beam of light from the optical pickup is irradiated based on the land prepit signal.

In the optical disk apparatus described above, however, when it records or reproduces a DVD-R/-RW which is not recorded as yet, the signal level of the land prepit component of the wobble signal is stable within the effective range, but when it records or reproduces a DVD-R/-RW is recorded already, the reflection factor at a land prepit adjacent a recording pit on the groove track is decreased. Thus, the optical disk apparatus described above has a problem in that the amount of returning light may be decreased by the decrease of the reflection factor to such a degree that the signal level of the land prepit component comes out of the effective range.

This arises from the fact that, when a beam of light of high output power is irradiated from the light source of the optical pickup, the reflection factor of the optical disk at the position at which the beam of light is irradiated is decreased by the heat energy of the beam of light, and this is because the spot diameter of the beam of light for recording is normally greater than the width of the groove track and therefore the reflection factor also of land prepits is dropped.

The optical disk apparatus has a problem also in that the signal level of the land prepit component of the wobble signal is lowered also by a tracking error which is an error of a tracking position. This decreases the effective range in binarization and deteriorates the accuracy in detection of a land prepit significantly.

Further, the signal level of the land prepit component of the wobble signal is dispersed also among different types of optical disks produced by different makers, and particularly the amount of returning light from a land prepit adjacent a recording pit on the groove track sometimes exhibits a great difference depending upon the type of the optical disk.

### SUMMARY OF THE INVENTION

It is an object of the present invention to provide an optical pickup apparatus which can appropriately detect a land prepit from an optical disk to produce a good land prepit signal.

It is another object of the present invention to provide an optical disk apparatus which can appropriately detect a land prepit from an optical disk to produce a good land prepit signal.

In order to attain the objects described above, according to an aspect of the present invention, there is provided an optical pickup apparatus, including a light source for emitting a beam of light of a predetermined wavelength, an objective lens for condensing the beam of light emitted from the light source upon an optical disk which has a wobbled groove track and a land track having land prepits representative of position information of the track, a light reception section having areas divided in parallel to a tangential direction to the track for receiving returning light of the beam of light reflected back from the optical disk and outputting signals corresponding to amounts of the received light by the areas, a control section for performing gain control of the signals for the individual areas outputted from the light reception section in the wobbling frequency or a frequency equal to an integral number of times of the wobbling frequency, and a production section for producing a signal corresponding to one of the land prepits based on the signals for the individual areas having the gains controlled by the control section.

In the optical pickup apparatus, the light reception section receives, at the areas thereof divided in parallel to a tangential direction to the track of the optical disk, returning light of the beam of light reflected back from the optical disk and outputs signals corresponding to amounts of the received light by the areas. The control section performs gain control of the signals for the individual areas outputted from the light reception section in the wobbling frequency or a frequency equal to an integral number of times of the wobbling frequency. Further, the production section produces a signal corresponding to one of the land prepits based on the signals for the individual areas having the gains controlled by the control section.

According to another aspect of the present invention, there is provided an optical disk apparatus, including disk rotational driving means for driving an optical disk, on which a wobbled groove track and a land track having land prepits representative of position information of the track, to rotate, and an optical pickup for recording and/or reproducing information onto and/or from the optical disk, the optical pickup including a light source for emitting a beam of light of a predetermined wavelength, an objective lens for condensing the beam of light emitted from the light source, a light reception section having areas divided in parallel to a tangential direction to the track for receiving returning light of the beam of light reflected back from the optical disk and outputting signals corresponding to amounts of the received light by the areas, a control section for performing gain control of the signals for the individual areas outputted from the light reception section in the wobbling frequency or a frequency equal to an integral number of times of the wobbling frequency, and a production section for producing a signal corresponding to one of the land prepits based on the signals for the individual areas having the gains controlled by the control section.

In the optical disk apparatus, the light reception section receives, at the areas thereof divided in parallel to a tangential direction to the track of the optical disk, returning light of the beam of light reflected back from the optical disk and outputs signals corresponding to amounts of the received light by the areas. The control section performs gain control of the signals for the individual areas outputted from the light reception section in the wobbling frequency or a frequency equal to an integral number of times of the wobbling frequency. Further, the production section produces a signal corresponding to one of the land prepits based on the signals for the individual areas having the gains controlled by the control section.

With the optical pickup apparatus and the optical disk apparatus, a land prepit signal can be produced appropriately. Consequently, even if the signals of the reception section have some imbalance or variation arising from some inclination of the disk, a displacement in tracking by a tracking error, a dispersion of amplifiers, a displacement of returning light from the optical disk, a displacement of the beam spot on the light reception element and so forth, a great range within which the land prepit signal can be binarized can be assured, and therefore, the land prepit signal can be detected appropriately.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a configuration of an optical disk apparatus to which the present invention is applied;

FIG. 2 is a schematic view showing a groove track and a land track on a signal recording face of an optical disk onto and from which an information signal can be recorded and reproduced by the optical disk apparatus of FIG. 1;

FIG. 3 is a schematic view showing a configuration of an optical pickup included in the optical disk apparatus of FIG. 1;

FIG. 4 is a circuit diagram showing a light reception element and a signal production section of the optical disk apparatus of FIG. 1;

FIG. 5 is a diagram illustrating a relationship between an output power ratio between two AGCs of the signal production section shown in FIG. 4 and the aperture ratio;

FIG. 6 is a waveform diagram illustrating a land prepit component at a maximum value of the amplitude of a wobble signal;

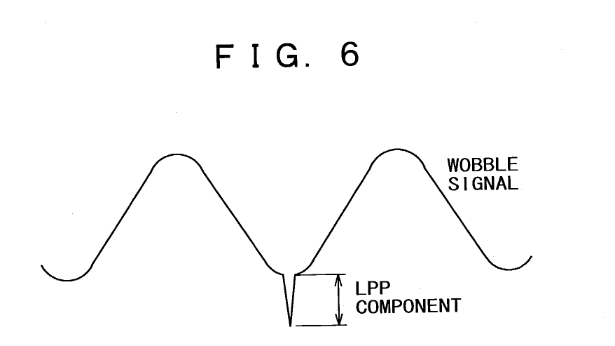

FIG. 7 is a waveform diagram illustrating a RF signal having a fixed amplitude level corrected by an equalizer and a gain control signal produced by a gain control signal production section of the optical disk apparatus of FIG. 1;

FIG. 8 is a graph illustrating a relationship among an offset voltage of an offset section, a ratio between amplification factors of two gain control amplifiers of the optical disk apparatus of FIG. 1, and the aperture ratio.

FIG. 9 is a circuit diagram of a modification to the optical disk apparatus of FIG. 1 which includes another light reception element and another signal reproduction section;

FIG. 10 is a block diagram showing a land prepit circuit of a conventional optical disk apparatus; and

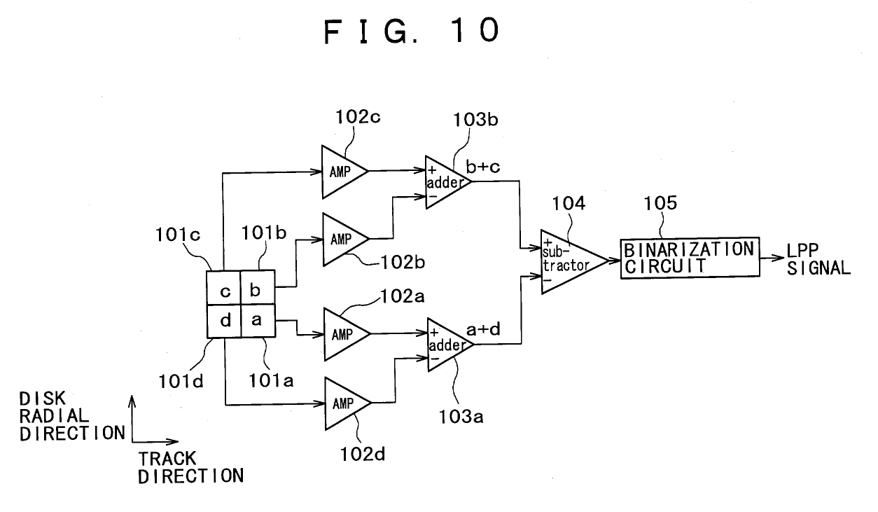

FIG. 11 is a waveform diagram illustrating an effective range in binarization of a land prepit component of a waveform of a RF signal.

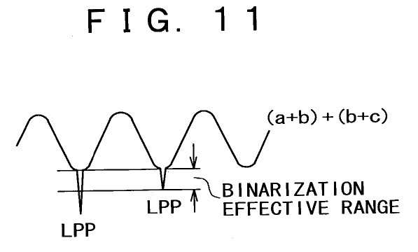

### DETAILED DESCRIPTION OF THE PREFERRED EMBODIMENTS

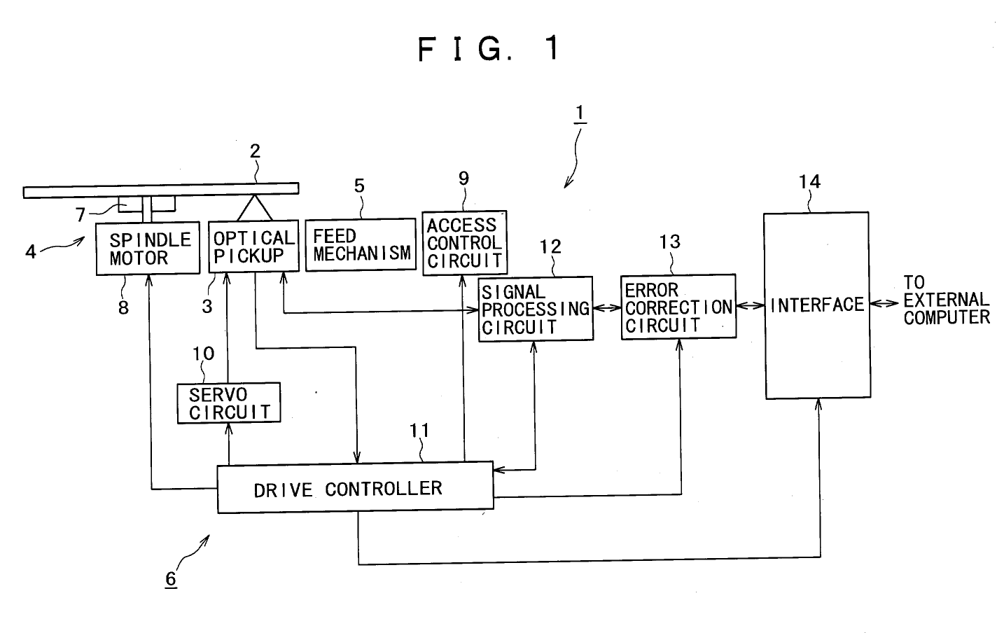

Referring to FIG. 1, there is shown an optical disk apparatus to which the present invention is applied. The optical disk apparatus is generally denoted by 1 and can record and/or reproduce information onto and/or from an optical disk 2 of the write-once-read-many type such as, for example, a DVD-R/-RW (Digital Versatile Disk-Recordable/-Rewritable).

The optical disk apparatus 1 includes an optical pickup 3 for recording and reproducing information onto and from an optical disk 2, a disk rotating driving mechanism 4 for driving the optical disk 2 to rotate, a feed mechanism 5 for feeding the optical pickup 3 in a diametrical direction of the optical disk 2, and a control section 6 for controlling the optical pickup 3, disk rotating driving mechanism 4 and feed mechanism 5.

The disk rotating driving mechanism 4 includes a disk table 7 for receiving the optical disk 2, and a spindle motor 8 for driving the disk table 7 to rotate. The feed mechanism 5 includes, though not shown, a support base for supporting the optical pickup 3, a main shaft and a sub shaft for supporting the support base for movement thereon, and a thread motor for moving the support base.

The control section 6 includes an access control circuit 9 for controlling driving of the feed mechanism 5 to control the position of the optical pickup 3 in a diametrical direction of the optical disk 2, a servo circuit 10 for controlling driving of two-axis actuators for the optical pickup 3, and a drive controller 11 for controlling the access control circuit 9 and the servo circuit 10. The control section 6 further includes a signal processing circuit 12 for demodulating a signal from the optical pickup 3 and modulating a signal to the optical pickup 3, an error correction circuit 13 for correcting errors of the signal obtained by the demodulation process by the signal processing circuit 12, and an interface 14 for outputting the signal after the error correction by the error correction circuit 13 to an external electronic apparatus such as an external computer and receiving a signal inputted from the external computer.

In the optical disk apparatus 1 having the configuration described above, the disk table 7 on which an optical disk 2 is placed is driven to rotate by the spindle motor 8 of the disk rotating driving mechanism 4 while the feed mechanism 5 is driven to move in accordance with a control signal from the access control circuit 9 of the control section 6 to move the optical pickup 3 to a position corresponding to a desired recording track of the optical disk 2 to record and/or reproduce information onto and/or from the optical disk 2.

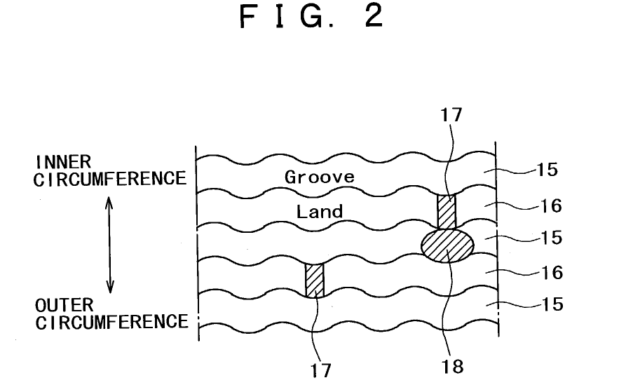

Referring to FIG. 2, groove tracks 15 formed from wobbled grooves and land tracks 16 formed from lands between adjacent ones of the groove tracks 15 are formed spirally or concentrically on the optical disk 2. Further, land prepits 17 are provided at predetermined distances on the land tracks 16 of the optical disk 2, and if information is recorded on any of the groove tracks 15, then a record mark 18 is formed.

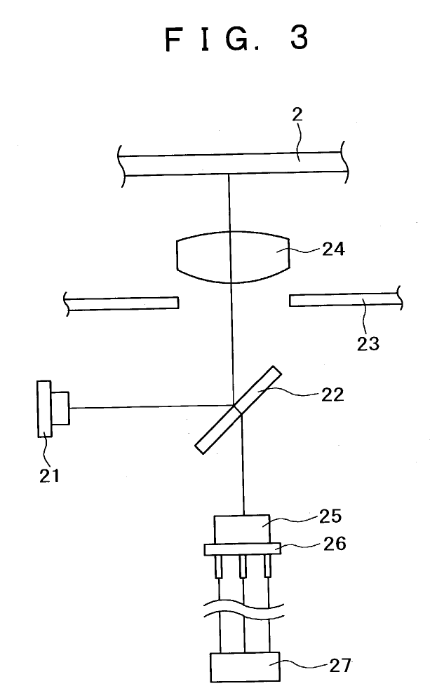

Referring to FIG. 3, the optical pickup 3 includes a light source 21 for irradiating a beam of light of a predetermined wavelength, a half mirror 22 for reflecting the beam of light emitted from the light source 21 and passing therethrough returning light reflected from the optical disk 2, an objective lens 23 for condensing the beam of light reflected by the half mirror 22 on the optical disk 2, an aperture stop 24 for contracting the beam of light to a predetermined numerical aperture between the half mirror 22 and the objective lens 23, a light reception element 25 for receiving the returning light having passed through the half mirror 22 and outputting a signal corresponding to the received amount of the returning light, an amplification section 26 for amplifying the level of the returning light received by the light reception element 25, and a signal production section 27 for producing various signals in response to an output of the amplification section 26.

The light source 21 is a light beam source for emitting a beam of light whose wavelength is approximately 650 nm and may be, for example, a semiconductor laser. It is to be noted that the wavelength of the beam of light to be emitted from the light source 21 is adjusted, for example, within a range of 650±20 nm so that recording and reproduction of information onto and from the optical disk 2 can be performed appropriately.

The half mirror 22 separates the optical path of the beam of light emitted from the light source 21 and the optical path of the returning light from the optical disk 2 from each other.

The objective lens 23 is an aspherical convex lens and condenses the beam of light reflected by the half mirror 22 so that the beam of light may form a spot of light of a predetermined diameter on the signal recording face of the optical disk 2.

The aperture stop 24 contracts the beam of light reflected by the half mirror 22 so that the beam of light may have a predetermined numerical aperture at a position immediately before the objective lens 23.

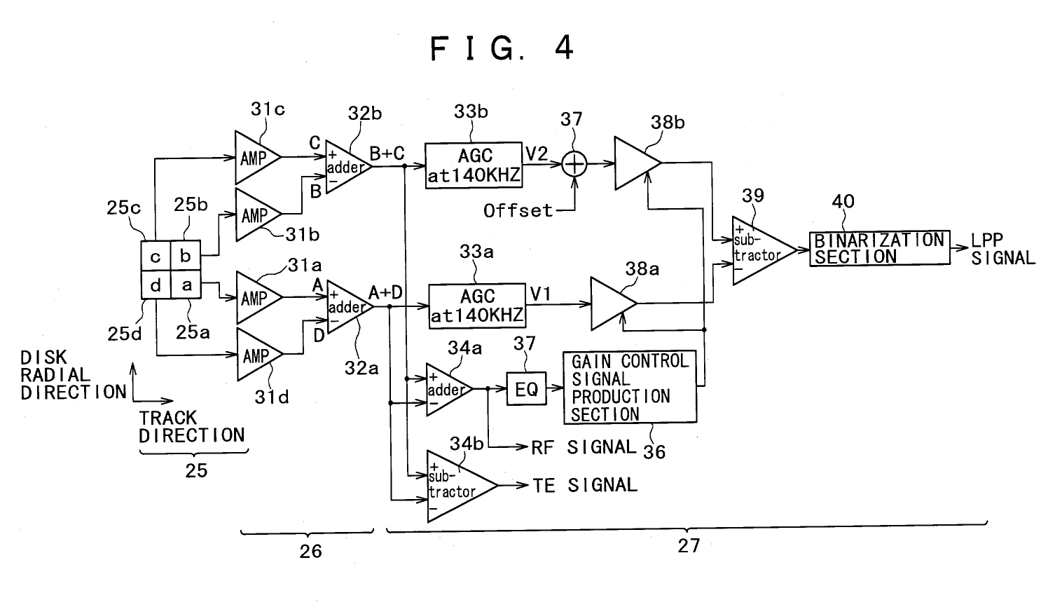

Referring to FIG. 4, the light reception element 25 has four light reception regions 25a, 25b, 25c and 25d divided by dividing lines extending in a direction of a track of the optical disk 2 and another direction perpendicular to the direction of a track, and outputs signals corresponding to received light amounts of the returning light from the optical disk 2 received by the light reception regions 25a, 25b, 25c and 25d to the amplification section 26.

The amplification section 26 includes I-V amplifiers 31a, 31b, 31c and 31d for converting signals inputted as variations of current into voltages, and adders 32a and 32b each for adding two signals inputted thereto. The signal production section 27 includes automatic gain controllers (AGCs) 33a and 33b each for controlling the gain of a signal inputted thereto, an adder 34a for adding two signals inputted thereto, a subtractor 34b for producing a difference signal between two signals inputted thereto, an equalizer 35 for correcting the frequency characteristic of a signal inputted thereto, a gain control signal production section 36 for producing a gain control signal, which is hereinafter described, to be used for the gain control, an offset section 37 for offsetting a signal inputted thereto, variable gain amplifiers 38a and 38b each for amplifying a signal inputted thereto, a subtractor 39 for producing a difference signal between two signals inputted thereto, and a binarization section 40 for binarizing the level of a signal inputted thereto within an effective range between a predetermined upper limit value and a predetermined lower limit value to produce a land prepit (LPP) signal. It is to be noted that the amplification section 26 and the signal production section 27 may be generally formed as a single package.

The I-V amplifiers 31a, 31b, 31c and 31d convert signals outputted from the light reception regions 25a, 25b, 25c and 25d f the light reception element 25 from variations in current to variations in voltage, respectively. It is to be noted that the voltage signals obtained by the conversion by the I-V amplifiers 31a, 31b, 31c and 31d are hereinafter referred to as signals A, B, C and D, respectively.

The adder 32a adds the signal A obtained by the conversion by the I-V amplifier 31a and the signal D obtained by the conversion by the I-V amplifier 31d to produce a signal A+D. Meanwhile, the adder 32b adds the signal B obtained by the conversion by the I-V amplifier 31b and the signal C obtained by the conversion by the IV amplifier 31c to produce a signal B+C.

The AGC 33a includes an AGC loop which in turn includes a band-pass filter not shown for extracting a signal of the frequency of a wobble signal read out from the wobbling of the optical disk 2, that is, a signal of the wobbling frequency, and extracts a wobble signal of approximately 140 kHz where the speed of rotation of the optical disk 2 is a linear velocity of 3.5 m/s. Further, the AGC 33a performs gain control of the signal A+D obtained by the addition by the adder 32a so that the amplitude level of the signal to be outputted therefrom may have a fixed value V1.

The AGC 33b includes, similarly to the AGC 33a, an AGC loop which in turn includes a band-pass filter not shown for extracting a signal of the wobbling frequency, and extracts a wobble signal of approximately 140 kHz where the speed of rotation of the optical disk 2 is a linear velocity of 3.5 m/s. Further, the AGC 33b performs gain control of the signal B+C obtained by the addition by the adder 32b so that the amplitude level of the signal to be outputted therefrom may have a fixed value V2.

The reason why the AGCs 33a and 33b perform gain control so that the amplitude levels V1 and V2 may be fixed with respect to the wobble signal in this manner is that, where the gain control is performed in this manner, a stabilized level of a land prepit component of the wobble signal is obtained irrespective of whether or not information is recorded on the optical disk 2.

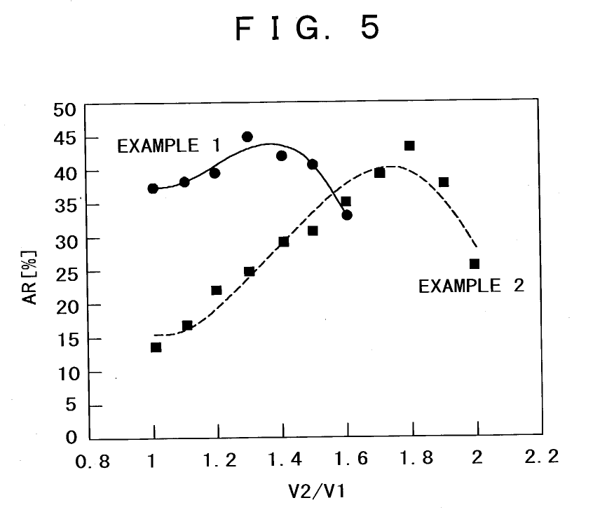

A variation of the level of the land prepit component caused by a variation of the ratio V2/V1 between the values V1 and V2 is represented by a relationship between the ratio V2/V1 and the aperture ratio (AR) as seen in FIG. 5. The aperture ratio represents a value obtained by comparison between the signal A+D and the signal B+C with regard to the difference between the level at a position at which the amplitude level of the wobble signal exhibits a maximum value and the level at a position at which the land prepit component exhibits a minimum value, and as the value thereof increases, a land prepit can be detected more likely.

In the graph of FIG. 5, variations in aperture ratio where different types of optical disks are used are shown, and a solid line curve indicates the variation of an example 1 while a broken line curve indicates the variation of an example 2. From the graph, it can be seen that, with the example 1, the best result is obtained where the ratio V2/V1 is approximately 1.4, and with the example 2, the best result is obtained where the ratio V2/V1 is approximately 1.8. While the value of the ratio V2/V1 is different depending upon the type of the optical disk 2 in this manner, the aperture ratio is improved and a land prepit component can be detected readily as much.

It is to be noted that, although such a ratio V2/V1 as described above is different depending upon the type of the optical disk 2 or the design of the optical pickup 3, where it is set to a value greater than 1, a land prepit signal can be read out appropriately. Further, the amplitude levels V1 and V2 are set to predetermined values in accordance with the configuration of the optical pickup 3 in advance.

The adder 34a further adds the signal A+D obtained by the addition by the adder 32a and the signal B+C obtained by the addition by the adder 32b to form a signal A+B+C+D, that is, a radio frequency (RF) signal.

The subtractor 34b subtracts the signal B+C obtained by the addition by the adder 32b from the signal A+D obtained by the addition by the adder 32a to form a signal (A+B)−(C+D), that is, a tracking error signal.

The equalizer 35 raises the gain in high frequency regions in order to correct the RF signal obtained by the addition by the adder 34a against comparative reduction of the amplitude in a high frequency region by a spatial frequency characteristic of the optical pickup 3 to make the amplitude level of a signal to be outputted fixed.

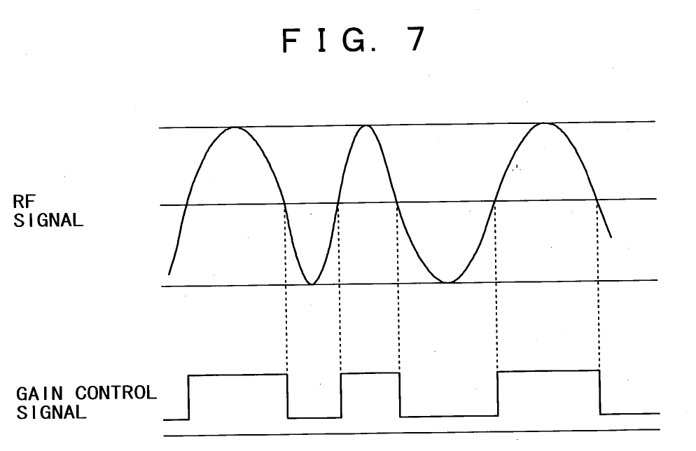

The gain control signal production section 36 binarizes the signal, whose frequency characteristic has been corrected by the equalizer 35, with a predetermined slice level to form a pulse signal and performs offset or level correction or the like for the pulse signal to produce a gain control signal for controlling the variable gain amplifiers 38a and 38b as seen in FIG. 7. Here, the gain control signal corresponds to a record mark 18 recorded on the optical disk 2.

The offset section 37 applies a predetermined offset to the signal whose gain has been controlled by the AGC 33b.

The variable gain amplifier 38a amplifies the signal, whose gain has been controlled by the AGC 33a, in accordance with the gain control signal from the gain control signal production section 36 so that the amplitude level of the signal may be increased to V3 times. Meanwhile, the variable gain amplifier 38b amplifies the signal, to which an offset has been applied by the offset section 37, in accordance with the gain control signal from the gain control signal production section 36 so that the amplitude level of the signal may be increased to V4 times.

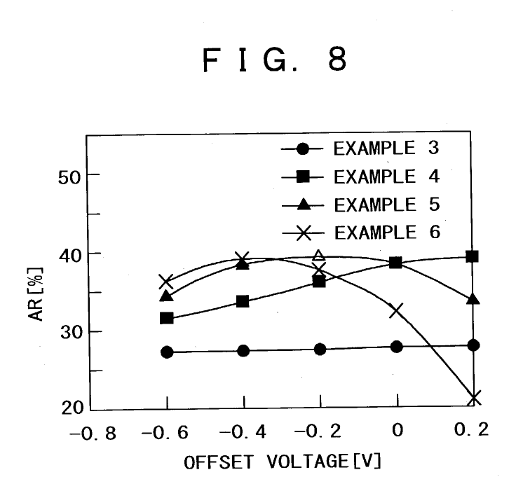

Here, the values V3 and V4 contribute to improvement of the aperture ratio as seen in FIG. 8. In FIG. 8, the aperture ratio where the ratio V3/V4 is 1 is represented as an example 3; the aperture ratio where the ratio V3/V4 is 1.2 is represented as an example 4; the aperture ratio where the ratio V3/V4 is 1.4 is represented as an example 5; and the aperture ratio where the ratio V3/V4 is 1.6 is represented as an example 6. The axis of abscissa of FIG. 8 represents the offset voltage applied from the offset section 37. It is to be noted that the values V3 and V4 are both higher than 1.

From the graph of FIG. 8, it can be seen that generally the example 5 exhibits good values, and a good aperture ratio is obtained where the offset voltage is −0.2 V.

The subtractor 39 subtracts the signal amplified by the variable gain amplifier 38a from the signal amplified by the variable gain amplifier 38b to produce a difference signal.

The binarization section 40 binarizes the signal level of the difference signal produced by the subtractor 39 within an effective range between a predetermined upper limit value and a predetermined lower limit value to detect a land prepit to produce a land prepit signal.

Operation of the components of the optical pickup 3 of the optical disk apparatus 1 having the configuration described above is described in connection with flows of signals outputted from the light reception element 25.

In the optical disk apparatus 1, a beam of light emitted from the light source 21 is reflected by the half mirror 22 of the optical pickup 3 and is contracted to a numerical aperture suitable for the optical disk 2 by means of the aperture stop 24, and is then condensed on the signal recording face of the optical disk 2 by the objective lens 23. Then, the optical pickup 3 condenses returning light reflected from the optical disk 2 by means of the objective lens 23, transmits the returning light through the half mirror 22 past the aperture stop 24, receives the returning light by the light reception regions 25a, 25b, 25c and 25d of the light reception element 25, and outputs signals corresponding to the amounts of the returning light received by the light reception regions 25a, 25b, 25c and 25d to the I-V amplifiers 31a, 31b, 31c and 31d, respectively.

The signals inputted to the I-V amplifiers 31a, 31b, 31c and 31d are converted into voltages by the I-V amplifiers 31a, 31b, 31c and 31d and outputted as signals A, B, C and D, respectively.

The signals A and D after the conversion into voltages by the I-V amplifiers 31a and 31d are outputted to the adder 32a while the signals B and C after the conversion into voltages by the I-V amplifiers 31b and 31c are outputted to the adder 32b.

The signals A and D outputted from the I-V amplifiers 31a and 31d are added by the adder 32a to form a signal A+D, which is outputted to the AGC 33a, adder 34a and subtractor 34b while the signals B and C outputted from the I-V amplifiers 31b and 31c are added by the adder 32b to form a signal B+C, which is outputted to the AGC 33b, adder 34a and subtractor 34b.

The signals A+D and B+C inputted to the adder 34a are further added by the adder 34a to form a signal A+B+C+D, that is, a RF signal, which is outputted to the signal processing circuit 12 in order to reproduce an information signal recorded on the optical disk 2 and outputted to the equalizer 35 in order to appropriately produce a land prepit signal.

The RF signal inputted to the equalizer 35 is subject to correction of the frequency characteristic thereof by the equalizer 35, by which the gain in a high frequency region is corrected to produce a RF signal of a fixed amplitude level. The RF signal of the fixed amplitude level is outputted to the gain control signal production section 36.

The signal inputted to the gain control signal production section 36 is sliced with a predetermined slice level by the gain control signal production section 36 so that it is binarized, and is outputted as a gain control signal to the variable gain amplifiers 38a and 38b.

Meanwhile, the signals A+D and B+C inputted to the subtractor 34b are subtracted by the subtractor 34b to produce a signal (A+D)−(B+C), that is, a tracking error signal, which is outputted to the signal processing circuit 12 in order to perform a tracking servo process.

The signal A+D inputted to the AGC 33a is subject to extraction of a wobble signal of approximately 140 kHz and then to gain control so that the amplitude level of the signal to be outputted may be equal to the amplitude level VI by the AGC 33a, and a resulting signal is outputted to the variable gain amplifier 38a.

The signal inputted to the variable gain amplifier 38a is amplified in accordance with the gain control signal outputted from the signal production section 27 by the variable gain amplifier 38a so that the amplitude level may be increased, for example, to V3 times, and a resulting signal is outputted to the subtractor 39.

Further, the signal B+C inputted to the AGC 33b is subject to extraction of a wobble signal of approximately 140 kHz and then to gain control so that the amplitude level of the signal to be outputted may be equal to the amplitude level VI by the AGC 33b, and a resulting signal is outputted to the offset section 37.

To the signal inputted to the offset section 37, a predetermined offset voltage is applied, and a resulting signal is outputted to the variable gain amplifier 38b.

The signal B+C inputted to the variable gain amplifier 38b is amplified by the variable gain amplifier 38b in accordance with the gain control signal outputted from the signal production section 27 so that the amplitude level may be increased, for example, to V4 times, and a resulting signal is outputted to the subtractor 39.

The signals A+D and B+C inputted to the subtractor 39 are subject to subtraction of the signal A+D from the signal B+C by the subtractor 39 to form a difference signal, which is outputted to the binarization section 40.

A land prepit component of the difference signal inputted to the binarization section 40 is binarized with a slice level within a predetermined effective range by the binarization section 40 and is outputted as an appropriate land prepit signal to the drive controller 11.

With the optical disk apparatus 1 described above, since the output levels of the AGC 33a and the AGC 33b are controlled so as to exhibit a fixed ratio, the aperture range is improved, and consequently, detection of a land prepit component is facilitated and a land prepit signal can be produced appropriately.

Further with the optical disk apparatus 1, since the amplification ratio between the variable gain amplifier 38a and the variable gain amplifier 38b is controlled so that the best aperture ratio may be obtained and, where a record mark 18 exists, the amplification ratio is raised in accordance with the gain control signal from the gain control signal production section 36 to improve the aperture ratio. Consequently, detection of a land prepit component is facilitated and a land prepit signal can be produced appropriately.

It is to be noted that the optical disk apparatus 1 may be modified such that the signal production section 27 changes over the gain control in response to presence or absence of a pit based on the RF signal read out. In the following, a configuration of the signal production section which changes over the gain control in response to presence or absence of a pit is described.

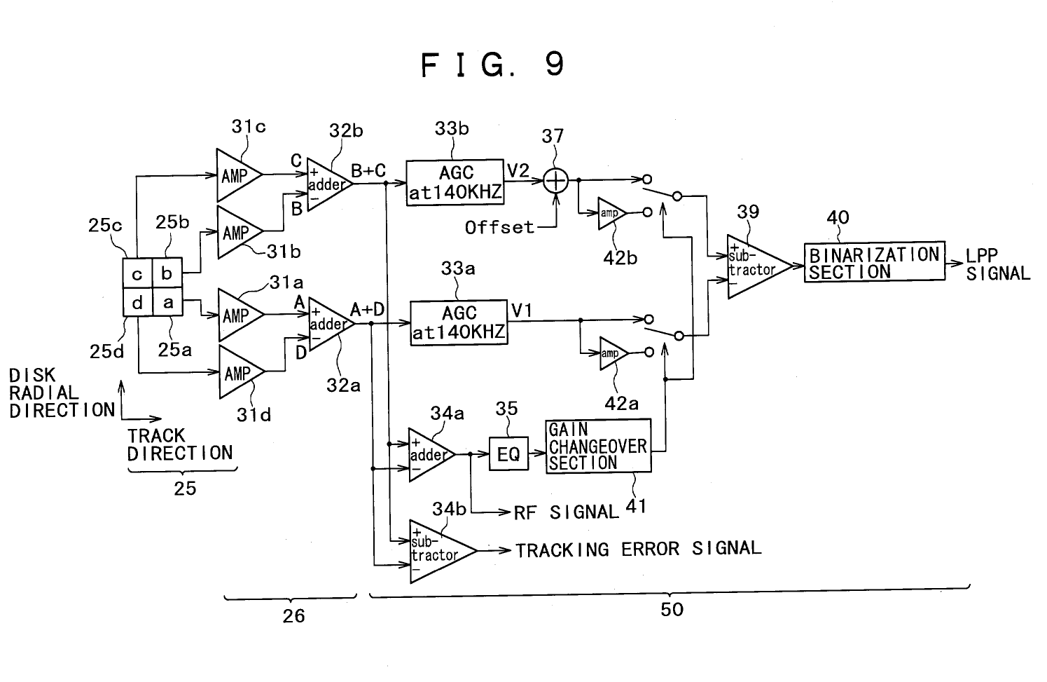

Referring to FIG. 9, the signal production section of the configuration described above is generally denoted by 50 and includes a pair of automatic gain controllers (AGCs) 33a and 33b each for performing gain control of a signal inputted thereto, an adder 34a for adding two signals inputted thereto, a subtraction section 34b for producing a difference signal between signals inputted thereto, an equalizer 35 for correcting the frequency characteristic of a signal inputted thereto, a gain changeover section 41 for changing over the gain control, an offset section 37 for offsetting a signal inputted thereto, a pair of gain amplifiers 42a and 42b each for amplifying a signal inputted thereto, a subtractor 39 for producing a difference signal between two signals inputted thereto, and a binarization section 40 for binarizing the level of a signal inputted thereto within an effective range between a predetermined upper limit value and a predetermined lower limit value to produce a land prepit signal.

The gain changeover section 41 discriminates whether or not a record mark 18 is present based on a pulse signal obtained by binarizing a signal, whose frequency characteristic has been corrected by the equalizer 35, with a predetermined slice level as seen in FIG. 7 to change over the circuit connection to the gain amplifiers 42a and 42b.

The gain amplifier 42a amplifies, when it is connected by the gain changeover section 41, the signal having a gain controlled by the AGC 33a so that the amplitude level of the signal may be increased to V3 times. Meanwhile, the gain amplifier 42b amplifies, when it is connected by the gain changeover section 41, the signal, to which an offset has been applied by the offset section 37, so that the amplitude level of the signal may be increased to V4 times.

Operation of the components of the optical pickup 3 of the optical disk apparatus 1 having such a configuration as described above is described along flows of signals outputted from the light reception element 25.

In the optical disk apparatus 1, a beam of light emitted from the light source 21 is reflected by the half mirror 22 of the optical pickup 3 and is contracted to a numerical aperture suitable for the optical disk 2 by means of the aperture stop 24, and is then condensed on the signal recording face of the optical disk 2 by the objective lens 23. Then, the optical pickup 3 condenses returning light reflected from the optical disk 2 by means of the objective lens 23, transmits the returning light through the half mirror 22 past the aperture stop 24, receives the returning light by the light reception regions 25a, 25b, 25c and 25d of the light reception element 25, and outputs signals corresponding to the amounts of the returning light received by the light reception regions 25a, 25b, 25c and 25d to the I-V amplifiers 31a, 31b, 31c and 31d, respectively.

The signals inputted to the I-V amplifiers 31a, 31b, 31c and 31d are converted into voltages by the I-V amplifiers 31a, 31b, 31c and 31d and outputted as signals A, B, C and D, respectively.

The signals A and D after the conversion into voltages by the I-V amplifiers 31a and 31d are outputted to the adder 32a while the signals B and C after the conversion into voltages by the I-V amplifiers 31b and 31c are outputted to the adder 32b.

The signals A and D outputted from the I-V amplifiers 31a and 31d are added by the adder 32a to form a signal A+D, which is outputted to the AGC 33a, adder 34a and subtractor 34b while the signals B and C outputted from the I-V amplifiers 31b and 31c are added by the adder 32b to form a signal B+C, which is outputted to the AGC 33b, adder 34a and subtractor 34b.

The signals A+D and B+C inputted to the adder 34a are further added by the adder 34a to form a signal A+B+C+D, that is, a RF signal, which is outputted to the signal processing circuit 12 in order to reproduce an information signal recorded on the optical disk 2 and outputted to the equalizer 35 in order to appropriately produce a land prepit signal.

The RF signal inputted to the equalizer 35 is subject to correction of the frequency characteristic thereof by the equalizer 35, by which the gain in a high frequency region is corrected to produce a RF signal of a fixed amplitude level. The RF signal of the fixed amplitude level is outputted to the gain changeover section 41.

The signal inputted to the gain changeover section 41 is sliced with a predetermined slice level so that it is binarized, and the gain changeover section 41 discriminates whether or not a record mark 18 is present based on the resulting binary value and changes over the circuit connection of the gain amplifiers 42a and 42b based on the discrimination.

Meanwhile, the signals A+D and B+C inputted to the subtractor 34b are subtracted by the subtractor 34b to produce a signal (A+D)−(B+C), that is, a tracking error signal, which is outputted to the signal processing circuit 12 in order to perform tracking servoing.

The signal A+D inputted to the AGC 33a is subject to extraction of a wobble signal of approximately 140 kHz and then to gain control so that the amplitude level of the signal to be outputted may be equal to the amplitude level V1 by the AGC 33a. Then, a resulting signal from the AGC 33a is outputted to the gain amplifier 42a when it is connected to the gain amplifier 42a by the gain changeover section 41, but is outputted to the subtractor 39 when it is not connected to the gain amplifier 42a.

The signal inputted to the gain amplifier 42a is amplified by the gain amplifier 42a so that the amplitude level may be increased, for example, to V3 times, and a resulting signal is outputted to the subtractor 39.

Further, the signal B+C inputted to the AGC 33b is subject to extraction of a wobble signal of approximately 140 kHz and then to gain control so that the amplitude level of the signal to be outputted may be equal to the amplitude level V1 by the AGC 33b, and a resulting signal is outputted to the offset section 37.

To the signal inputted to the offset section 37, a predetermined offset voltage is applied. Then, a resulting signal from the offset section 37 is outputted to the gain amplifier 42b when the offset section 37 is connected to the gain amplifier 42b by the gain changeover section 41, but is outputted to the subtractor 39 when the offset section 37 is not connected to the gain amplifier 42b.

The signal B+C inputted to the gain amplifier 42b is amplified by the gain amplifier 42b in accordance so that the amplitude level may be increased, for example, to V4 times, and a resulting signal is outputted to the subtractor 39.

The signals A+D and B+C inputted to the subtractor 39 are subject to subtraction of the signal A+D from the signal B+C by the subtractor 39 to form a difference signal, which is outputted to the binarization section 40.

A land prepit component of the difference signal inputted to the binarization section 40 is binarized with a slice level within a predetermined effective range by the binarization section 40 and is outputted as an appropriate land prepit signal to the drive controller 11.

With the optical disk apparatus 1 described above, since the output levels of the AGC 33a and the AGC 33b are controlled so as to exhibit a fixed ratio, the aperture range is improved, and consequently, detection of a land prepit component is facilitated and a land prepit signal can be produced appropriately.

Further, with the optical disk apparatus 1, since the amplification ratio between the gain amplifier 42a and the gain amplifier 42b is set so that the best aperture ratio may be obtained and, when a record mark 18 is present, the gain amplifiers 42a and 42b are connected by the gain changeover section 41 to raise the amplification ratio of the signal to improve the aperture ratio. Consequently, detection of a land prepit component is facilitated and a land prepit signal can be produced appropriately.

Furthermore, with the optical disk apparatus 1, since the gain amplifiers 42a and 42b having a fixed gain are used without using variable gain amplifiers, the circuit configuration can be simplified when compared with the alternative circuit configuration which includes the variable gain amplifiers 38a and 38b.

While a preferred embodiment of the present invention has been described using specific terms, such description is for illustrative purposes only, and it is to be understood that changes and variations may be made without departing from the spirit or scope of the following claims.

What is claimed is:

1. An optical pickup apparatus, comprising:
a light source for emitting a beam of light of a predetermined wavelength;
an objective lens for condensing the beam of light emitted from said light source upon an optical disk which has a wobbled groove track and a land track having land prepits representative of position information of the track;
a light reception section having areas divided in parallel to a tangential direction to the track for receiving returning light of the beam of light reflected back from the optical disk and outputting signals corresponding to amounts of the received light by the areas;
a control section for performing gain control of the signals for the individual areas outputted from said light reception section in the wobbling frequency or a frequency equal to an integral number of times of the wobbling frequency; and
a production section for producing a signal corresponding to one of the land prepits based on the signals for the individual areas having the gains controlled by said control section.

2. An optical pickup apparatus according to claim 1, wherein said control section performs the gain control for the signals for the areas outputted from said light reception section individually with predetermined outputs.

3. An optical pickup apparatus according to claim 1, wherein said control section detects presence or absence of a pit recorded on the groove of the optical disk based on a radio frequency signal obtained by adding the signals for the areas outputted from said light reception section and changes over the gain control in response to the detected presence or absence of a pit.

4. An optical pickup apparatus according to claim 3, wherein said control section applies an offset to one of the signals for the areas to change over the gain control.

5. An optical disk apparatus, comprising:
disk rotational driving means for driving an optical disk, on which a wobbled groove track and a land track having land prepits representative of position information of the track, to rotate; and
an optical pickup for recording and/or reproducing information onto and/or from the optical disk, said optical pickup including a light source for emitting a beam of light of a predetermined wavelength, an objective lens for condensing the beam of light emitted from said light, a light reception section having areas divided in parallel to a tangential direction to the track for receiving returning light of the beam of light reflected back from the optical disk and outputting signals corresponding to amounts of the received light by the areas, a control section for performing gain control of the signals for the individual areas outputted from said light reception section in the wobbling frequency or a frequency equal to an integral number of times of the wobbling frequency, and a production section for producing a signal corresponding to one of the land prepits based on the signals for the individual areas having the gains controlled by said control section.

6. An optical disk apparatus according to claim 5, wherein said control section performs the gain control for the signals for the areas outputted from said light reception section individually with predetermined outputs.

7. An optical disk apparatus according to claim 5, wherein said control section detects presence or absence of a pit recorded on the groove of the optical disk based on a radio frequency signal obtained by adding the signals for the areas outputted from said light reception section and,changes over the gain control in response to the detected presence or absence of a pit.

8. An optical disk apparatus according to claim 7, wherein said control section applies an offset to one of the signals for the areas to change over the gain control.
